(19) United States
(12) Patent Application Publication
(10) Pub. No.: US 2006/0149400 A1
(43) Pub. Date: Jul. 6, 2006

(54) Audio streaming player

(75) Inventors: Yau Man Choi, Hong Kong (HK); Chen Tse Shih, Sanchong City (TW)

Correspondence Address: BRUCE H. TROXELL;SUITE 1404, 5205 LEESBURG PIKE, FALLS CHURCH, VA, 22041, US

(73) Assignee: KJC International Company Limited

(21) Appl. No.: 11/028,577

(22) Filed: Jan. 5, 2005

(51) Int. Cl. G06F 17/00

(52) U.S. Cl. 700/94

(57) ABSTRACT

An Audio streaming player, which can play the audio streaming by connecting to the Internet with a wired or wireless interface, the Audio streaming player can connect the audio streaming provider servers and play the audio streaming provided by these servers; the audio streaming player is composed with a programmable components for updating the codec and software with each particular audio streaming file format, and the behaviors control of this device is also pre-programmed; Moreover, the processing unit is for calculate the decode or code scheme and output a digitalized signals, besides the memory unit of this device provides the buffering space and storage place for the usage when decoding a audio stream, storing a address list server or other memorize requests; users can play the audio streaming by the cooperation of programmable components, memory units, digital signal processors, and Input/Output interfaces that belongs to this device.

### FIELD OF THE INVENTION

The present invention relates to an Audio streaming player, and more particularly to an analog and digital audio streaming radio, which also may provide the function of recording.

### BACKGROUND OF THE INVENTION

For the popularity of the Internet, many media operators such as TVs or radios have shifted their media contents and usage on to the Internet to provide a farther broadcasting distance. The users always receive these broadcasting by computers connected to the Internet. Therefore, users can receive these broadcasts from a farther distance that is not restricting by the transmission media (or even language barrier), such as receiving a Hong Kong radio program in the USA. These restricting transmission media could be wired line or radio wave, although it can provide a good quality of service, it cannot provide services out from a certain range. Therefore, a combination of the Internet and the audio streaming technologies will provide a worldwide broadcasting ability.

The users usually receive Internet audio streaming through an Internet connected desktop computer. And if the user needs a mobile ability, a notebook or a moveable computer system such as PDA that can connect to the Internet and display audio streaming is required. However, there is no demand for all the functions of a whole computer system. Only the function of playing audio streaming is required to be separated as an independent device. The users can play the audio streaming by this simple device to achieve the requirements.

Currently, there is no such audio streaming device like the present invention; especially the present invention does not contain unusable functions other than audio streaming usages. Moreover, servers for these types of audio streaming device can be constructed for the convenience and speed for the receiving of the audio streaming.

### SUMMARY OF THE INVENTION

It is an object of the present invention to provide an audio streaming player, which can connect to the Internet and play audio streaming. This audio streaming player can play the latest audio formats by updating the software or codec, it also has the ability to record audios and replay tagged audios. This audio streaming player can connect to the Internet by a wired line, through wireless connection, or both. Moreover, the net address of the audio streaming provider servers can not only be setup by users but can also provide by a centralized address list server. The users can also update the address list on the centralized address list server in order to make the lists more complete.

This audio streaming player is composite by the following characters:
1. This device is an audio streaming player, which can play the latest audio streaming and output audio signals by updating the software or codec.
2. This device composite with a FPGA (Field Programmable Gate Array) for recording the control states, which can update for to the latest codec or software specification. The ability for updating can be optional.
3. The audio signal output of this device can be built internally or externally. The output signals can also be analog or digital.
4. The input interface of this device can work through the Internet or through other audio input interface.
5. This device can provide a simple setup method to the address of the audio streaming provider servers. Moreover, the centralized address list server is a platform for exchanging and providing the address.
6. This device can automatically search and memorize the address of the audio streaming provider servers, which allows the users can have newest address lists.

For the popularity of the Internet, users can play audio streaming by using this device with a wired line or wireless connection. It is convenient for users who need to receive international messages or from someone reside abroad. Moreover, the construct of the centralized address list server can provide users a simpler way to setup their favorite address lists in the device for the convenience of usage. Otherwise, the device can also provide the record function and audio input interface which allows the users to play their favorite audio segment or for other usages.

### BRIEF DESCRIPTION OF THE DRAWINGS

Reference will now be made, by way of example only, to drawings of the invention, which illustrate the preferred embodiment of the invention, and in which:

FIG. 1: The system construct view of the connection between the present invention and Internet.

FIG. 2: The system structure view of the present invention.

FIG. 3: The external view of an executive view of the device (front view).

FIG. 4: The external view of an executive view of the device (side view).

### DETAILED DESCRIPTION OF THE PREFERRED EMBODIMENTS

The present invention is composite by the following components which provide the ability for connecting to the Internet, playing audio streaming, recording audio, updating software, and memorizing the address of the audio streaming provided servers.

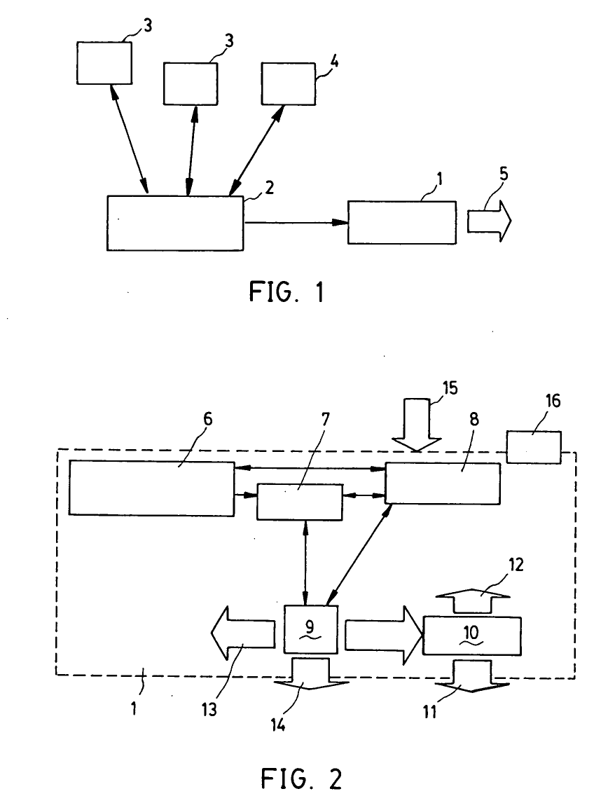

Referring to FIG. 1 and FIG. 2, the audio streaming player 1 is connected to Internet 2 through the Internet connect port 6. Through this connection, device 1 can connect the audio streaming provider server 3 and the centralized address list server 4. The major function of the centralized address list server 4 is to provide the address of the audio streaming provider servers, which allows the users to grab their favorite servers easily. Here in, the users can also update the address of the audio streaming provider servers in order to completely download the contents of the centralized address list server. The output of the audio signal of the device 1 can be internally or externally with analog or digital signal. Users can choice an internal output or external output to fit their requirements.

Another aspect of the device, the major components such as Internet connection port 6, which can be designed wired or wireless. The Internet connection port 6 can receive the audio stream and after that the FPGA 7 will check the format of the received audio stream. Here in, the FPGA 7 is pre-programmed and can provide the suitable decode program for a particular audio streaming specification. The decode programs can be stored in the FPGA 7 or memory spaces 8, the memory spaces can be constructed by a non-volatile or a volatile type of memory units such as, FLASH memory, SDRAM (Synchronous Dynamic Random Access Memory). The received audio stream can be decoded by the cooperation of DSP (Digital Signal Processor) 9, FPGA 7 and memory spaces 8. After that, the audio signal can be a digitalized output. Moreover, if an analog audio signal output 11 is required, a DAC (Digital to Analog Converter) 10 can be used for transferring the signals. The analog audio signal can be output to an internal 12 or external 11 speakers or earphones. The audio signal representation devices can be analog 11, 12 or digital 13, 14. Therefore, the device 1 can represent a high-end quality by using a digital output interfaces.

The memory spaces 8 in this device can be use for storing the codec, and can also store the setups by the users such as the address of audio stream provider servers 3. Furthermore, through the connection of the Internet 2, the device 1 can download the address of audio stream provider servers 3 from the centralized address list server 4 and store these lists in the memory space 8. The memory space 8 can be automatically updated or manually update by the users, the data updated is not only the codec and address of audio stream provider servers but also the controls. That is, the memory space 8 provides the device 1 with any memorizing behaviors.

The recode function of this device 1 can be directly recorded or record by codec. The input of the audio signal can be Internet 2 or by using a universal audio input interface 15, such as microphone or AV connectors. The recorded data can be stored in memory space 8 for replay. Here in, if the input audio signal is an analog signal, we can use an ADC (Analog to Digital Converter) 16 to transfer the analog signal into the digital signal in order to be the digital input signal of FPGA 7 or other components in this device 1.

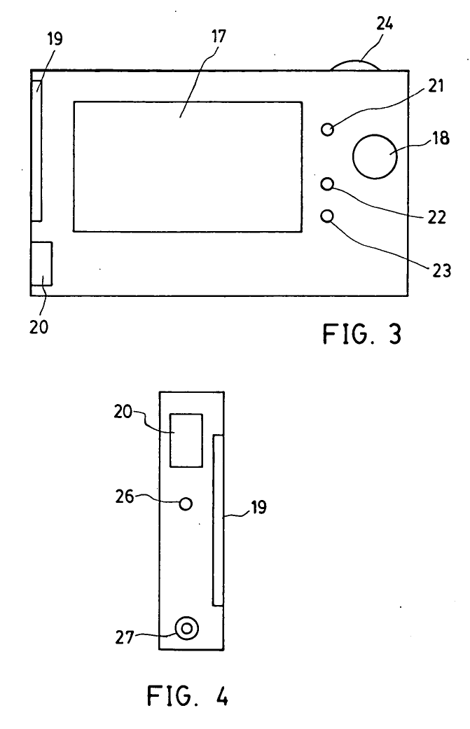

The FIG. 3 and FIG. 4 are the external look of this device. There is a display screen 17 or more screens for displaying the address of audio stream provider server 3. The users can control this device 1 by using the control button 18 for choosing the functions. The internal wireless Internet connection port 19 and wired port 20 can be used for connecting to Internet 2. There are lighting signals 21, 22, 23 for displaying the situations of the signal states, playing states, and power states, respectively. The volume can be adjusted by the volume control 24 and the audio signal can be output by external port 26. The power supply can be batteries or can be supported by the connection of an adaptor 27.

The device 1 can connect to the Internet by a wired or wireless method. The protocol can be TCP/IP or others. The major function of the protocol is to locate the audio stream provider server or centralized address list server. That is, besides the wired connection there is also the use of Bluetooth, 802.11, or IrDA to be the transmission media for connecting this device 1 and Internet 2. The configurations of the network connection can be stored in the memory space 8 to make a simpler usage. The usage of these transmission media can be alone or combined; users can decide the usage of these media.

The audio stream can be received from the Internet connection interface 6. The FPGA 7 of the device 1 can differentiate the file format of the audio stream and provide the latest particular codec, such as RM, ASF, or WMA. The codec can be stored in FPGA 7 or memory space 8 and can be accessed any time when needed. The FPGA 7 can differentiate the file format of the audio stream and get the particular codec, after that the DSP 9 can decode the audio stream by the particular decode and output the digital audio signal. The FPGA 7 can be reprogrammed at any time through the connection of Internet for the latest decode or other functions on this device 1.

The FPGA 7 can control the behavior of the device 1, by input method, audio output specification; adjust the quality of audio, or connection methods. All of the settings and the interface between user and device 1 can be controlled and programmed by FPGA 7. The memory space 8 can also support memory required from FPGA 7.

The memory space 8 of this device 1 can be constructed by many kinds of method. The major function of the memory space 8 is for storing the user settings, device settings, and address of audio stream provider servers. All of the memorize behavior of this device 1 can provide by the memory space 8. The construction of memory space can be FLASH memory, EPROM (Erasable Programmable Read Only Memory), SDRAM, or Hard Disk. And the data in the memory space 8 should still exist when the power is down.

The memory space 8 can be constructed by the combination of a Non-volatile or a volatile memory unit. The volatile memory unit can be used for decode buffering or as an Internet connection buffer. The Non-volatile memory unit is for storing the data that can be used several times. That is, the usage and the construction of the memory space are according to the unit behavior of this device 1.

The DSP 9 of this device 1 is in response for the calculation of decode, which the power is its ability for the latest codec or higher for the future. The DSP 9 can decode the audio stream and output the digital audio signal. The digital audio signal can be displayed by internal or external audio representation devices.

For the analog internal 12 or external 11 audio representation devices, the device 1 content a DAC 10 to transfer a digital signal into an analog signal for representation of an analog audio signal. The analog audio signal can be the input of an audio representation device, such as speaker or earphone.

The power supply of this device 1 can be the battery or through a wired power line for providing an AC or DC power. The AC power should covert to DC by a transformer to make the device 1 acceptable. The users can decide the powered method to make the device moveable (battery) or immovable (wired).

The memory space 8 of this device 1 can extend the usage for storing the recorded data and users can also download the audio data into memory space 8 for playing. The input of the audio is not restricted on the Internet connection port 6, that is, the other audio input interface 15 is available for the device 1, such as microphone or AV connection. The record function can work by using the same flow as decode. The input audio can be coded by the cooperation of FPGA 7, DSP 9 and memory space 8. And the analog audio input can be transfer by an ADC 16 into a digital audio signal for code the input audio signal. The ADC 16 can be an internal module or external connect.

From above, the components of this device 1 can also be constructed by other units, and are not restricted to the description above. The other unit can take the same behavior of each component which is the field of the present invention, such as modifying a FPGA 7 to an un-programmable unit, changing the storing media for memory space 8, migrating the Internet connection interface 19, or decoding by the other processor. The same behavior of the unit in this device 1 for memorize, calculate or Input/Output are in the field of the present invention.

What is claimed is:

1. An audio streaming player, which constitute by code unit, decode unit and memory unit, the codec and software can be updated for each particular audio stream format; this audio streaming player can receive the audio data and decode the audio data by the cooperation between the processor, memory, and programmable units for output the audio signal; the audio streaming player comprising: a) programmable unit: process the code or decode behavior and control the behavior of the operation; b) memory space: the memorize function for storing the user settings, provide the buffering space for code or decode function; c) processor: to calculate the code or decode scheme for an audio stream or for response the user controls; d) digital and analog outputs: providing the internal or external audio signal outputs for a decoded audio stream.

2. The audio streaming player of claim 1, wherein the programmable unit can be realized by using a FPGA, which makes an update of codec simple.

3. The audio streaming player of claim 1, wherein the programmable unit can be realized by using a un-programmable unit, the only requirement is the behavior of code or decode and the operation of users should be achieve.

4. The audio streaming player of claim 1, wherein the construction of the memory space can be Non-volatile type or volatile type of memory unit.

5. The audio streaming player of claim 1, wherein the address of the audio stream provider server can be setup by user or receive from a centralized address list server.

6. The audio streaming player of claim 1, wherein the processor unit can be realized by using a DSP.

7. The audio streaming player of claim 1, wherein the processor unit can be realized by using any processor, the ability for code or decode the audio stream and the operations of user controls is the requirement.

8. The audio streaming player of claim 1, wherein the input and output of the audio signal can be analog signal or digital signal. Moreover, the audio outputs can be displayed on internal or external audio representation device.

9. The audio streaming player of claim 1, wherein the input and output of the audio can be the input through an Internet connection, and other universal or specific audio input interface.

10. The audio streaming player of claim 1, wherein the input and output interface of the audio, which includes all of the audio input/output, and network Input/Output interfaces.

11. The audio streaming player of claim 1, further comprising a recording function.
